(19) United States
(12) Patent Application Publication
(10) Pub. No.: US 2008/0140552 A1
(43) Pub. Date: Jun. 12, 2008

(54) Methods of processing a check in an automatic signature verification system

(75) Inventor: Andrew Blaikie, Waterloo (CA)

Correspondence Address: Michael Chan;NCR Corporation, Law Department, Intellectual Property Section, 1700 South Patterson Blvd., Dayton, OH, 45479-0001, US

(73) Assignee: NCR Corporation

(21) Appl. No.: 11/634,701

(22) Filed: Dec. 6, 2006

(51) Int. Cl. G06Q 40/00

(52) U.S. Cl. 705/35

(57) ABSTRACT

A method is provided of a bank processing a check in an automatic signature verification system. The method comprises receiving a check image having a payor's signature, extracting the payor's signature from the check image, comparing the extracted payor's signature with a reference signature, providing a confidence value based upon the comparison of the extracted payor's signature with the reference signature, selecting one of a plurality of confidence threshold values based upon amount of the check, and comparing the confidence value with the selected confidence threshold value to determine if payment of the check amount is approved.

### BACKGROUND

The present invention relates to automatic signature verification systems, and is particularly directed to methods of processing a check in an automatic signature verification system.

A known system for detecting fraudulent checks is an automatic signature verification system in which a payor's signature on a check is compared with a “reference” signature for the checking account of the particular check. The comparison is automated in that there is no human intervention. The reference signature is typically an image of a signature from a signature card which was completed when the checking account was opened. If the signatures match, then payment of the check amount is approved. However, if the signatures do not match, then payment of the check amount is not approved and a human operator is alerted of a potentially fraudulent check.

From time to time, the payor's signature on a check is authentic, but for some reason does not match the reference signature. The mismatch of signatures could occur for any number of different reasons. As an example, the mismatch of signatures could occur because of the natural variation of a person's signature. As another example, the manner in which the check was scanned may be different from the manner in which the signature card was scanned, resulting in different image resolutions, orientations, and the like. As still another example, the quality of the reference signature on the signature card may be relatively poor as compared to the quality of the payor's signature on the check. This could occur if, for example, the signature card was previously migrated from an older system.

A determination of a signature mismatch when the payor's signature on the check is in fact authentic is known as a “false positive”. The total number of false postives in a single day may be large. As an example, the rate of false positives may be thirty percent, and the total number of checks being processed by the automatic signature verification system may be, for example, over 10,000 checks. If 10,000 checks are processed and the rate of false positives is thirty percent, then there would be approximately 3,000 checks in a single day for manual review.

Since the number of false positives presented to a human operator for manual review would be relatively large, an unfavorable business case may arise where the cost to review exceeds the cost of the fraud losses avoided. Or equally problematic, the manual review process may be unsuccessful because of the “needle in the haystack” syndrome in which a human operator may not be alert enough to identify and sort out the relatively few checks from a group of thousands of checks presented for manual review. It would be desirable to reduce the number of false positives presented to a human operator for manual review so that the human operator can focus on fewer checks and, therefore, perform the job more quickly and with greater accuracy.

### SUMMARY

In accordance with an embodiment of the present invention, a method of a bank processing a check in an automatic signature verification system comprises receiving a check image having a payor's signature, extracting the payor's signature from the check image, comparing the extracted payor's signature with a reference signature, providing a confidence value based upon the comparison of the extracted payor's signature with the reference signature, selecting one of a plurality of confidence threshold values based upon amount of the check, and comparing the confidence value with the selected confidence threshold value to determine if payment of the check amount is approved.

### BRIEF DESCRIPTION OF THE DRAWINGS

In the accompanying drawings:

FIG. 1 is a schematic diagram representation of an example known automatic signature verification system;

FIG. 2 is a flow diagram which depicts steps of a known process used in the system of FIG. 1;

FIGS. 3A and 3B are tables which illustrate a known relationship between a confidence threshold and the number of false positives associated with this confidence threshold used in the known process of FIG. 2;

FIGS. 4A and 4B are tables similar to the tables of FIGS. 3A and 3B, and which illustrate another known relationship between a different confidence threshold and the number of false positives associated with this confidence threshold;

FIG. 5 is a flow diagram which depicts steps of a sub-process which is usable in the process of FIG. 2 and which is in accordance with an embodiment of the present invention; and

FIGS. 6A and 6B are tables which illustrate a relationship, in accordance with an embodiment of the present invention, between tiered recognition confidence threshold values and the number of false positives associated with these tiered recognition confidence threshold values used in the sub-process of FIG. 5.

### DETAILED DESCRIPTION

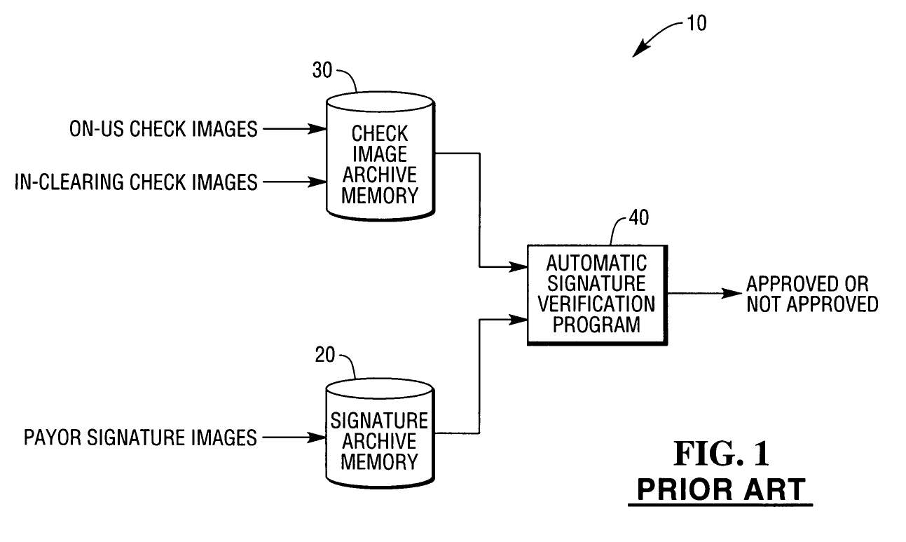

A known automatic signature verification system 10 is illustrated in FIG. 1. The automatic verification system 10 is typically operated by a financial institution such as an international bank. As shown in FIG. 1, a signature archive memory 20 contains a number of signatures which were previously obtained from individuals opening up checking accounts with the international bank. Typically, an individual opening up a checking account initially signs a signature card. The signature card is then scanned to capture an image of the individual's signature. The captured signature image is stored in the signature archive memory 20.

A check image archive memory 30 contains a number of check images. Typically, the check images are provided from two different sources. One source is from on-us checks which have been cashed by the international bank. The other source is from in-clearing checks which have cashed by another bank (i.e., the presenting bank), and subsequently sent to the international bank (i.e., the paying bank) in a check clearing process.

During operation of the automatic signature verification system 10, an automatic signature verification program 40 compares an image of a payor's signature from a check image contained in the check image archive memory 30 with an image of a “reference” signature contained in the signature archive memory 20. The checking account number associated with the check image is used to determine which reference signature is to be retrieved from the signature archive memory 20 for comparison with the payor's signature from the check. Based upon this comparison, the program 40 provides an indication as to whether payment of the check is approved or not approved.

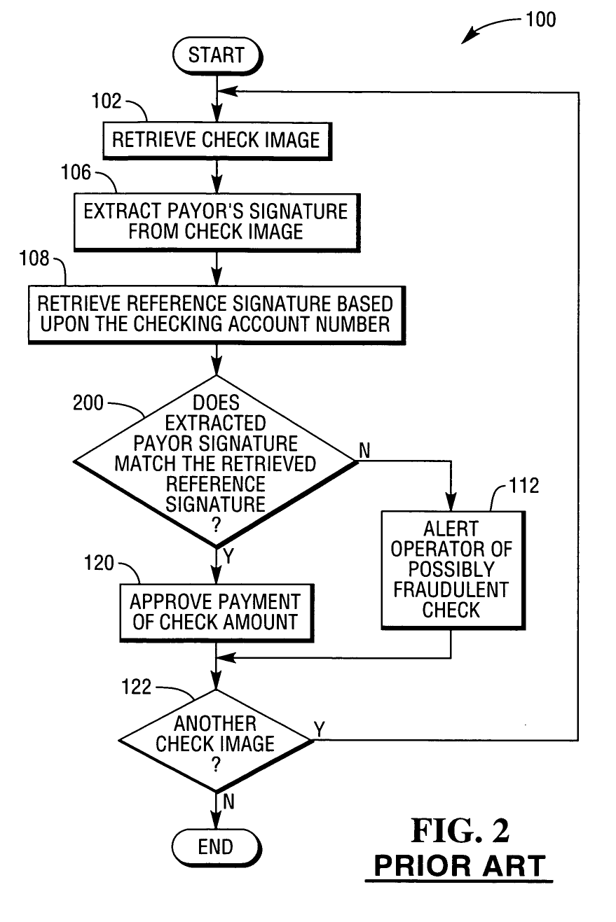

Referring to FIG. 2, a flow diagram 100 depicts steps of a known automatic signature verificaton process. In step 102, a check image from either an on-us check or an in-clearing check is retrieved from the check image archive memory 30. Then, in step 106, the payor's signature contained in the check image is extracted from the check image. As shown in step 108, a reference signature is retrieved from the signature archive memory 20. The particular reference signature retrieved is based upon the checking account number associated with the present check.

A determination is then made in step 200 as to whether the extracted payor's signature from step 106 matches the retrieved reference signature from step 108. If the determination in step 200 is negative (i.e., signatures do not match), then a bank operator is alerted that the present check may be fraudulent, as shown in step 112. The process then proceeds to step 122 to determine if there is another check image to be processed. If the determination in step 122 is affirmative, the process returns to step 102 to retrieve the next check image from the check image archive memory 30 to be processed. If the determination in step 122 is negative (i.e., there are no other check images), then the process terminates.

However, if the determination in step 200 is affirmative (i.e., the signatures do match), then payment of the amount of the present check is approved, as shown in step 120. The process then proceeds to step 122 to determine if there is another check image to be processed. If the determination in step 122 is affirmative, the process returns to step 102 to retrieve the next check image from the check image archive memory 30 to be processed. If the determination in step 122 is negative (i.e., there are no other check images), then the process terminates.

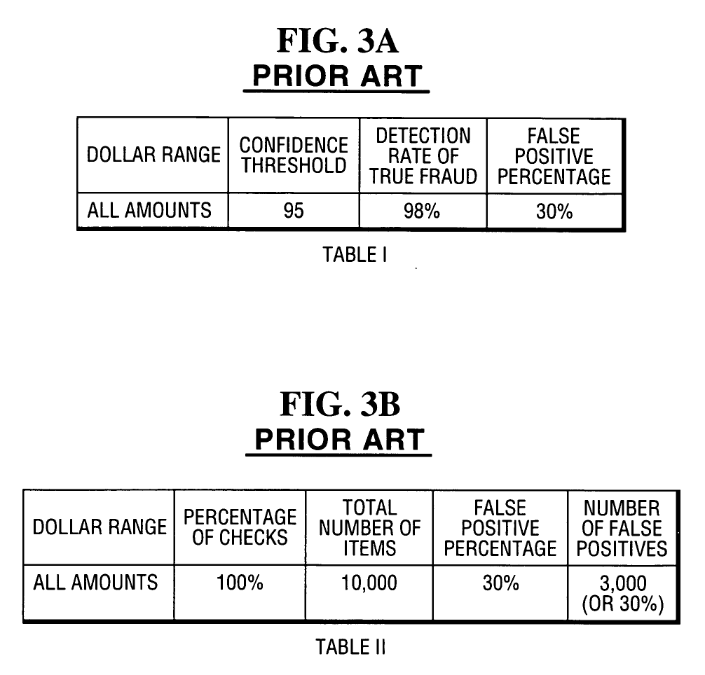

Referring to FIGS. 3A and 3B, a Table I and a Table II are illustrative of a known relationship between a confidence threshold value and the number of false positive items associated with the confidence threshold when 200 shown in FIG. 2 is carried out. It should be noted that a check item is considered to be a mismatch when the recognition confidence value is determined to be below the confidence threshold value. As shown in Table I in FIG. 3A, when a confidence threshold value of ninety-five (95) is used, there is a ninety-eight (98) percent detection rate of true fraud and a thirty (30) percent rate of false positives. Given a total number of 10,000 check items and a thirty percent rate of false positives for all check amounts, there would be a total number of 3,000 false positives (i.e., 30% of 10,000 items), as shown in Table II in FIG. 3B.

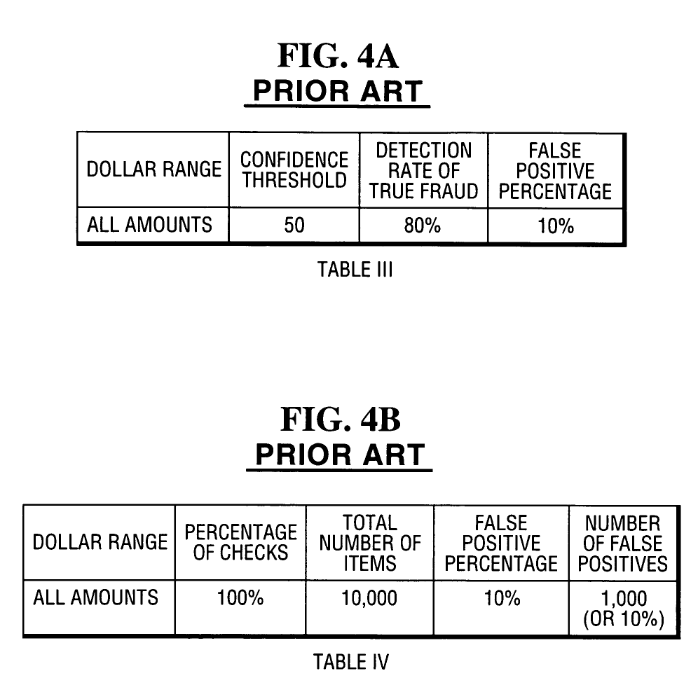

Referring to FIGS. 4A and 4B, a Table III and a Table IV are illustrative of a known relationship between a different confidence threshold value and the number of false positive items associated with this confidence threshold when 200 shown in FIG. 2 is carried out. Again, it should be noted that a check item is considered to be a mismatch when the recognition confidence for the particular check item is determined to be below the confidence threshold value. As shown in Table III in FIG. 4A, when a confidence threshold value of fifty (50) is used, there is an eighty (80) percent detection rate of true fraud and a ten (10) percent rate of false positives. Given again a total of 10,000 check items and now this time a ten percent rate of false positives for all check amounts, there would be a total number of 1000 false positives (i.e., 10% of 10,000 items), as shown in Table IV in FIG. 4B.

It should be apparent that in the known relationships depicted in FIGS. 3A, 3B, 4A, and 4B, the total number of false positives for all check amounts decreases as the confidence threshold value is set lower. However, there is a drawback to setting a lower confidence threshold value because some check items will be missed as a true positive. While it may-be acceptable to miss some lower amount checks which are true positives, it would not be acceptable to miss some higher amount checks which are true positives because this would result in too great of a financial loss.

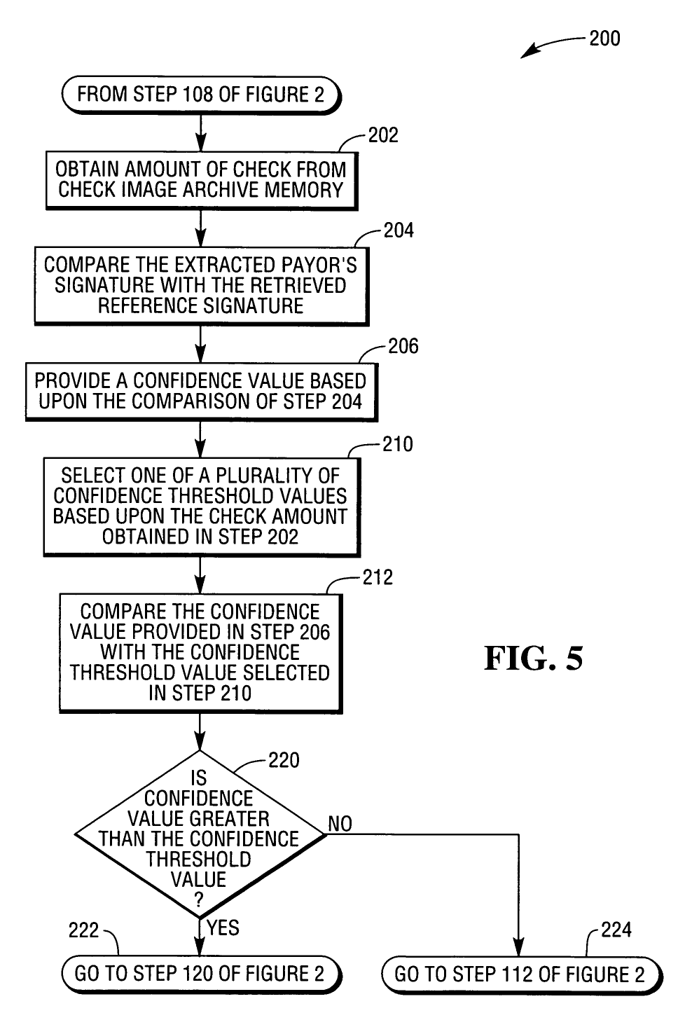

Referring to FIG. 5, a sub-process 200 in accordance with an embodiment of the present invention is illustrated. The sub-process illustrated in FIG. 5 is used in step 200 of the process 100 shown in FIG. 2. In step 202, the check amount is obtained from the check image archive memory 30. Typically, the check amount is contained in a check data file which is stored along with the corresponding check image in the check image archive memory 30. In step 204, the payor's signature extracted in step 106 is compared with the reference signature retrieved in step 108. Then, in step 206, a confidence value is determined and provided based upon the comparison of step 204. The comparison in step 204 and the providing of a confidence value in step 206 based upon that comparison are known and, therefore, will not be described.

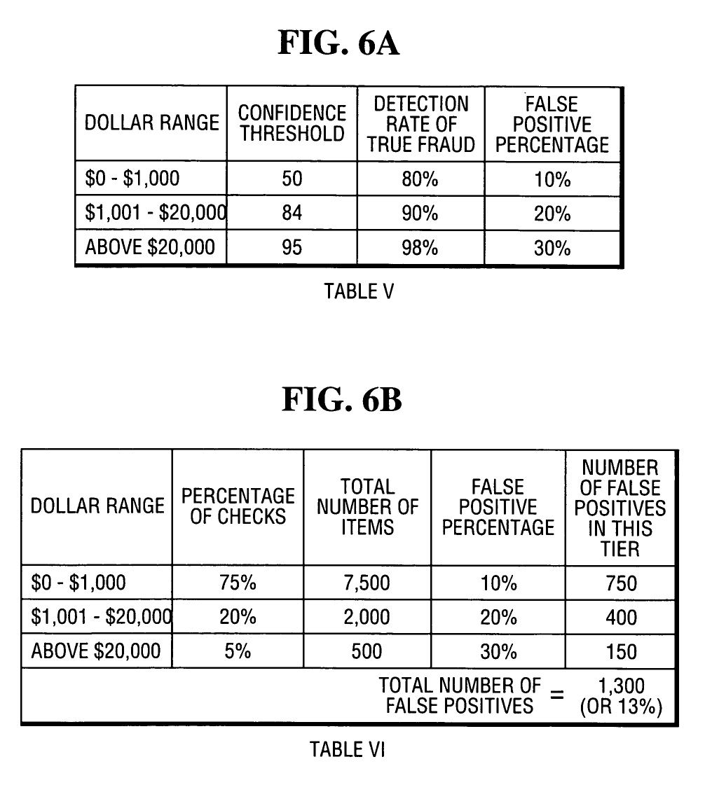

In step 210, one of a plurality of recognition confidence threshold values is selected based upon the check amount obtained in step 202. These plurality of confidence threshold values are tiered as will be better explained hereinbelow with reference to FIGS. 6A and 6B. Then, in step 212, the confidence value provided in step 206 is compared with the confidence threshold value selected in step 210. A comparison is then made in step 220 to determine whether the confidence value provided in step 206 is greater than the confidence threshold value selected in step 210. If the determination in step 220 is affirmative (i.e., the confidence value is greater than the confidence threshold value), then the sub-process of FIG. 5 proceeds to step 120 of the process of FIG. 2 to approve payment of the check amount. However, if the determination in step 220 is negative (i.e., the confidence value is less than or equal to the confidence threshold value), then the sub-process of FIG. 5 proceeds to step 112 of the process of FIG. 2 to alert an operator of a possibly fraudulent check. Payment of the check amount is not approved.

Referring to FIGS. 6A and 6B, a Table V and a Table VI are illustrative of a relationship, in accordance with an embodiment of the present invention, between the plurality of recognition confidence threshold values and the number of false positives associated with these plurality of confidence threshold values. As shown in Table V in FIG. 6A, when the amount of the check item is up to $1000, a first confidence threshold value of fifty (50) is used. When the first confidence threshold value of fifty is used, there is an eighty (80) percent detection rate of true fraud and a ten (10) percent rate of false positives. Also, as shown in Table V in FIG. 7A, when the amount of the check item is between $1001 and $20,000, a second confidence threshold value of eighty-four (84) is used. When the second confidence threshold value of eighty-four is used, there is a ninety (90) percent detection rate of true fraud and a twenty (20) percent rate of false positives. Further, as shown in Table VI in FIG. 6A, when the amount of the check item is over $20,000, a third confidence threshold value of ninety-five (95) is used. When the third confidence threshold value of ninety-five is used, there is a ninety-eight (98) percent detection rate of true fraud and a thirty (30) percent rate of false positives.

Assuming that only about seventy-five (75) percent of all the check items being processed has an amount up to $1000 and given a false positive percentage of ten percent for these checks, there would be a total of 750 false positives, as shown in Table VI in FIG. 6B. Similarly, assuming that only about twenty (20) percent of all the check items being processed has an amount between $1001 and $20,000 and given a false positive percentage of twenty percent for these checks, there would be a total of 400 false positives, as shown in Table VI in FIG. 6B. Again, similarly, assuming that the remaining five (5) percent of all checks have an amount over $20,000 and given a false positive percentage of thirty percent for these checks, there would be a total of 150 false positives, as shown in Table VI in FIG. 6B. Accordingly, the total number of all false positives using the tiered confidence threshold values of FIG. 6A is 1300 (i.e., 750+400+150) as shown in Table VI in FIG. 6B.

It should be apparent that the use of a plurality of different recognition confidence threshold values (i.e., the tiered confidence threshold values shown in Table V in FIG. 6A) results in a relatively higher percentage (30% in this example) of false positives for those check items which have amounts over $20,000, and a relatively lower percentage (10% in this example) of false positives for those check items which have amounts up to $1000. The percentage of false positives for those check items which have amounts between $1001 and $20,000 is 20% which is between the 30% (for check amounts over $20,000) and the 10% (for check amounts up to $1000).

It should be noted that the total number of false positives in Table VI in FIG. 6B for check amounts over $20,000 and presented for manual review is 150. This 150 number in Table VI in FIG. 6B is the same as the total number of false positives in Table II in FIG. 3B for check amounts over $20,000 (i.e., 5% of all checks (10,000) is equal to 500 checks, and a 30% false positives rate makes the total number of false positives equal to 150). While the total number of false positives in Table VI in FIG. 6B would be the same as the total number of false positives in Table II in FIG. 3B for amounts over $20,000, it should be noted that the total number of false positives in Table VI in FIG. 6B for all check amounts (i.e., 1300) is significantly less than the total number of false positives in Table II in FIG. 3B for all check amounts (i.e., 3,000). The reduction from 3,000 to 1300 false positives for all check amounts is a significant reduction of the total number of checks which need to be reviewed by the human operator. Since the human operator has significantly fewer checks to review, the operator can better focus on the relatively fewer checks. With better focus, the operator can perform the job of reviewing the checks more quickly and with greater accuracy.

Moreover, it should be noted that even though the total number of checks which need to be reviewed by the human operator has been reduced, the total number checks in the relatively higher amounts (i.e., over $20,000) in Table VI in FIG. 6B is substantially the same as the total number of checks over $20,000 in Table II in FIG. 3B. In this regard, note from FIG. 3B that the total number of checks over $20,000 is 500 (i.e., 5% of 10,000), and that the number of false positives for these 500 checks is 150 (i.e., 30% of 500). This number of 150 false positives associated with FIG. 3B is the same as the number of 150 false positives associated with Table VI in FIG. 6B. Accordingly, by using a plurality of different recognition confidence threshold values as illustrated in FIGS. 5, 6A, and 6B, the result is a significant reduction of total number of false positives for all check amounts (as evidenced by the reduced number of false positives from 3,000 to 1300 for all check amounts as just described hereinabove) with essentially no reduction of the total number of false positives in the higher amount checks (as evidenced by the unchanged number of 150 false positives for check amounts over $20,000 also as just described hereinabove).

Although the above description of Table V in FIG. 6A describes three different dollar ranges with different confidence threshold values, it is conceivable that less than three (i.e., only two) or more than three different dollar ranges with different confidence threshold values be used. It should also be noted that all of the numbers used in the tables of FIGS. 6A and 6B are just examples to show relationships. Accordingly, the specific dollar ranges illustrated in FIG. 6A are only examples, and the specific confidence threshold values illustrated in FIG. 6A are also only examples.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A method of a bank processing a check in an automatic signature verification system, the method comprising:
receiving a check image having a payor's signature;
extracting the payor's signature from the check image;
comparing the extracted payor's signature with a reference signature;
providing a confidence value based upon the comparison of the extracted payor's signature with the reference signature;
selecting one of a plurality of confidence threshold values based upon amount of the check; and
comparing the confidence value with the selected confidence threshold value to determine if payment of the check amount is approved.

2. A method according to claim 1, further comprising:
alerting a bank operator for manual review of the check if the determination is made that the payment of the check amount is not approved.

3. A method according to claim 1, wherein the check image comprises an image of a check which is an on-us check received from a customer of the bank.

4. A method according to claim 1, wherein the check image comprises an image of a check which is an in-clearing check received from another bank.

5. A method of a bank processing a check in an automatic signature verification system, the method comprising:
receiving the check;
extracting a payor's signature from the check;
retrieving a reference signature;
obtaining a check amount associated with the check;
comparing the extracted payor's signature with the retrieved reference signature;
providing a confidence value based upon the comparison of the extracted payor's signature with the retrieved reference signature;
selecting a first confidence threshold value if the check amount is below a first predetermined amount;
selecting a second confidence threshold value which is different from the first confidence threshold value if the check amount is above a second predetermined amount;
comparing the confidence value with the selected confidence threshold value;
determining if payment of the check amount is approved based upon the comparison of the confidence value with the selected confidence threshold value.

6. A method according to claim 5, further comprising:
alerting a bank operator for manual review of the check if a determination is made that the payment of the check amount is not approved.

7. A method according to claim 5, wherein the first predetermined amount is less than the second predetermined amount.

8. A method according to claim 5, wherein the first predetermined amount and the second predetermined amount are the same.

9. A method according to claim 5, further comprising:
selecting a third confidence threshold value if the check amount is between the first predetermined amount and the second predetermined amount.

10. A method according to claim 5, wherein the check comprises a check which is an on-us check received from a customer of the bank.

11. A method according to claim 5, wherein the check comprises a check which is an in-clearing check received from another bank.

12. A method of a bank processing an on-us check, the method comprising:
receiving the on-us check from a bank customer;
scanning the on-us check to provide an image of the check;
extracting a payor's signature from the check image;
retrieving a reference signature;
obtaining a check amount associated with the on-us check;
comparing the extracted payor's signature with the retrieved reference signature;
providing a confidence value based upon the comparison of the extracted payor's signature with the retrieved reference signature;
selecting one of a plurality of confidence threshold values based upon the check amount;
comparing the confidence value with the selected confidence threshold value; and
determining if payment of the check amount is approved based upon the comparison of the confidence value with the selected confidence threshold value.

13. A method according to claim 12, wherein the check is presented to a bank operator for manual review of the on-us check when payment of the check amount is not approved.
